(19) United States
(12) Patent Application Publication
(10) Pub. No.: US 2023/0309569 A1
(43) Pub. Date: Oct. 5, 2023

(54) GLUTEN-FREE BAKED GOODS

(71) Applicant: Intercontinental Great Brands LLC, East Hanover, NJ (US)

(72) Inventors: Tana Guan, East Hanover, NJ (US); Elena Hawkins, East Hanover, NJ (US); Lynn Haynes, East Hanover, NJ (US); Robert L. Magaletta, East Hanover, NJ (US); Katherine Oftedal, East Hanover, NJ (US); Mahesh Padmanabhan, East Hanover, NJ (US); Jennifer Spaldo, East Hanover, NJ (US); James Spinks, Reading (GB); Ye Yu, Suzhou (CN)

(21) Appl. No.: 18/018,840

(22) PCT Filed: Jul. 21, 2021
(86) PCT No.: PCT/US2021/042487

§ 371 Date: Jan. 30, 2023

Related U.S. Application Data
(60) Provisional application No. 63/059,755, filed on Jul. 31, 2020.

(51) Int. Cl. A21D 13/066; A21D 2/18; A21D 13/047

(52) U.S. Cl. CPC A21D 13/066; A21D 2/186; A21D 13/047

(57) ABSTRACT

Biscuits such as cookies are provided that are free of gluten, or that have reduced levels of gluten, and contain pre-gelatinized starch that, despite absence or low levels of gluten, have taste, texture, and other properties similar to baked goods made with wheat flour.

### FIELD

The present disclosure relates to gluten-free food products made with starch-based wheat substitutes, and methods of making such products.

### BACKGROUND

Baked goods come in a variety of forms, with varying appearances, textures, flavors, and other characteristics. In particular, biscuits such as cookies and the like are provided in a variety of shapes, sizes, and thicknesses. Some forms of cookies optionally contain fillings encapsulated in, or sandwiched between, layers of baked dough, or contain one or more of a wide variety of inclusions, coatings, or toppings. Inclusions vary the texture and/or flavor of the cookie, providing added crunch, chewiness, creaminess, or other characteristics.

Many baked goods contain one or more types of glutens, a group of proteins that are the predominate proteins found in cereal grains. Glutens occur in wheat species, barley, rye, and oats, as well as in products derived from these grains. When mixed with water, the gluten protein forms a strong, cohesive dough that will retain gas during proofing and baking. The viscoelastic property provided by gluten protein is fundamental in making many traditional baked products. Glutens, especially Triticeae glutens, have viscoelastic and adhesive properties, which give dough its elasticity, helping it rise and keep its shape and often leaving the final product with a chewy texture. These properties have led to wide use of gluten in the food industry.

However, gluten can trigger adverse inflammatory, immunological, and autoimmune reactions in some people, including celiac disease, non-celiac gluten sensitivity, dermatitis herpetiformis, gluten ataxia, and other disorders. Celiac disease, in particular, has demanded increased attention in recent years. Celiac disease is an autoimmune disorder that affects people of all ages. When people with celiac disease eat foods or use products made from plants that contain gluten, the mucous membrane of the small intestine is damaged. Celiac disease affects people differently, and symptoms can range from diarrhea or abdominal pain to irritability or depression.

The gluten protein content in bakery goods made from traditional flour far exceeds the maximum amount of gluten that a celiac person can tolerate at the standard consumption level. Therefore, the treatment for celiac disease is generally to follow a gluten-free diet, meaning that individuals with celiac disease avoid eating grains, bread, pizza, pasta, cereal, tortillas, and many other processed foods that contain gluten. Reducing or eliminating gluten levels in the diet can have a variety of benefits for individuals that that suffer from gluten sensitivity or celiac disease, such as increasing energy levels, promoting healthy weight gain, reducing bloating, reducing joint pain, reducing frequency of headaches, reducing depression, assisting in lactose digestion, improving bone and skin health, and reducing hair loss. It is also believed that gluten-free products have a variety of health benefits even for individuals that do not suffer from celiac disease or gluten sensitivity, which has led to a trend of expanding gluten-free product offerings.

However, despite their growing popularity, most commercially-available gluten-free food items fail to have the same taste and texture as products made with gluten. Commercially available gluten-free baked goods generally have a dense, crumbly, and sandy or granular texture, poor mouthfeel, inferior appearance, and a relatively short shelf life when compared to wheat-containing equivalent products. Compared with dough made from traditional flour, gluten-free doughs generally have lower cohesiveness and elasticity. The available dough-based methods produce sticky dough which is problematic in manufacturing and results in poor-quality products. Some gluten-free processing methods rely on liquid batter rather than dough, and as a result are not suitable for manufacturing using traditional processing. Moreover, while numerous gluten-free formulations have been proposed for bread, available gluten-free alternatives for denser, crunchy foods like cookies are generally less acceptable.

It would therefore be desirable to enable the manufacture of gluten-free products with organoleptic properties similar to those of traditional products.

### SUMMARY

Biscuits, cookies, and crackers, may be provided that are free of gluten or that have reduced levels of gluten yet have taste, texture, and other properties similar to their traditional counterparts made with traditional wheat flour or a normal amount of gluten. As used herein, “free of gluten” or “gluten-free” refers to a baked good having no more than the maximum amount of gluten permissible under one or more definitions of gluten-free according to applicable standards or regulations. For instance, in the United States 20 ppm gluten or less is considered “gluten-free” per FDA regulations. In some aspects, biscuits are manufactured containing pre-gelatinized starch, such as pre-gelatinized waxy corn starch used in certain embodiments. In some forms, the baked good may include combinations of flour, starch, and gums to yield a high strength matrix that imitates the properties of products made with traditional wheat flour. In some forms, pre-gelatinized starch is blended with other components to create a stronger network within a dough. Doughs for making such baked goods are also described herein. In some forms, light microscopy and confocal microscopy techniques are able to show differences in the matrix of gluten-free products made according to the invention in comparison to commercially-available gluten-free compositions. In some form, biscuits or other goods made in accordance with the invention have a higher break force than other low-gluten or gluten-free alternatives, and are more resistant to breakage during manufacturing and distribution. Products made in accordance with the invention have a formula that is closer to wheat in processability and texture than commercial gluten-free flour blends.

### BRIEF DESCRIPTION OF THE DRAWINGS

FIG. 1 is a flow chart demonstrating examples of steps of manufacturing a gluten-free cookie consistent with one embodiment of the invention.

FIGS. 2a-2c demonstrate the results of testing the structural integrity of several samples when subjected to varying concentrations of water and ethanol for 1 minute.

FIG. 3 is a graph showing results of testing for certain organoleptic characteristics of certain embodiments in comparison to non-inventive samples.

FIG. 4 is a graph of solvent retention capacity in water for various preferred and non-preferred flour blends in accordance with certain aspects of specific embodiments of the invention.

FIG. 5 is a graph of solvent retention capacity in a sodium carbonate solution for various preferred and non-preferred flour blends in accordance with certain aspects of specific embodiments of the invention.

FIG. 6 is a graph of solvent retention capacity in a sucrose solution for various preferred and non-preferred flour blends in accordance with certain aspects of specific embodiments of the invention.

### DETAILED DESCRIPTION

It has now been shown that baked biscuits, cookies, and crackers can be prepared without gluten from a dough comprising pre-gelatinized starch. Such a dough provides a final, baked product that can be made to have a desirable taste, texture, appearance, and baking properties similar to products made with significant amounts of gluten. In some forms, a biscuit, cracker, or cookie, can generally comprise flour, fat, sweetener, and pre-gelatinized starch. The biscuit, cracker, or cookie can further optionally comprise any fillings, coatings, toppings, and/or inclusions known in the art.

Generally, a biscuit, cookie, or cracker can be prepared from a dough including any one or more wheat substitutes comprising pre-gelatinized starch, such as pre-gelatinized waxy corn starch. The pre-gelatinized starch may comprise, for instance, about 3-10 wt. % of the finished baked good. In some particular aspects, the wheat substitute may comprise blends of gluten-free (or low-gluten) flour, starches, and/or gums. In some embodiments, white or brown rice flour, oat flour, buckwheat flour, teff flour, sorghum flour, and/or raw potato flour, are blended with one or more pre-gelatinized starches and optionally native rice starch, sago starch, tapioca starch or potato starch or corn starch. These blends generally comprise approximately 30-85 wt. %, more particularly 40-60 wt. %, and preferably about 50 wt. % of the dough. In some forms, the wheat replacer may comprise about 30-70 wt. % rice, oat flour, potato flour, buckwheat flour, teff flour, and/or sorghum flour. In some particular embodiments, the wheat replacer comprises about 55 wt. % rice flour, about 30 wt. % tapioca starch, about 15 wt. % pre-gelatinized starch, and about 0.5-1.5 wt. % hydrocolloid and in some examples includes about 15-35 wt. % white rice flour, about 20-40 wt. % brown rice flour, about 20-40 wt. % tapioca starch, about 5-25 wt. % pre-gelatinized corn starch, and about 1% hydrocolloid such as xanthan gum.

In some embodiments, gluten-free flours used in the invention have a D90 of less than about 125 μm. In some embodiments the gluten-free flours may have a D50 of less than about 60 μm. In some embodiments the gluten-free flours may have a D10 of less than about 15 μm.

In some aspects, biscuits, cookies, and crackers may comprise levels of lecithin and other emulsifiers of similar HLB (Hydrophile-Lipophile Balance) value from about 0.2 to about 2 wt. % in order to reduce or prevent oiling out and improve processability of low-gluten or gluten-free biscuit doughs. Without being bound by theory, it is believed that relatively high levels of lecithin may impact fat dispersion and assist in providing a texture approximating gluten-containing products.

Biscuits, cookies, and crackers optionally can also be prepared from a dough including flaxseed, chia, fiber sourced from oat, chicory root (inulin), corn or other sources, protein, i.e. milk powder, whey, pea or chickpea, or beans.

Generally, to some extent it is thought that integrity of a baked good depends on the degree of protein association and networking within the baked good. Without wishing to be bound by any particular theory, it is believed that dough including a wheat substitute comprising pre-gelatinized starch provides more evenly dispersed starch to provide an improved network within the dough when compared to known gluten-free alternatives.

Generally, a gluten-free product also can be prepared from a dough including any one or more suitable fats in any suitable amounts. In some forms the biscuits, cookies, and crackers may contain about 3 wt. % to about 15 wt. % fat in the finished baked goods. Any fats known in the art for use in biscuits, cookies, or crackers may be used. Without limitation, such fats may include solid fats or oils such as butter, canola oil, cocoa butter, coconut oil, corn oil, cottonseed oil, flaxseed oil, grape seed oil, lard, margarine, olive oil, palm kernel oil, palm oil, peanut oil, rapeseed oil, rice bran oil, safflower oil, sesame oil, soybean oil, suet, sunflower oil, tallow, vegetable oil, avocado oil, or vegetable shortening. In some aspects, a dough or biscuit can include a blend of any two or more fats. In an embodiment, a dough and biscuit comprise a vegetable-based fat (canola or rapeseed oil, palm and/or palm kernel oil). A dough can generally include fat in any useful amount such as amounts ranging from about 3 to about 17 wt. %, or about 5 to about 15 wt. %, of a total weight of the dough or biscuit.

A gluten-free baked good also can be prepared from a dough generally including any one or more suitable sweeteners in an amount effective to impart sweetness to the baked good. In some forms, biscuits, cookies, and crackers may contain about 1 wt. % to about 32 wt. % sweetener in the finished baked goods. Any fats and sweeteners (such as sugars, syrups, and artificial sweeteners) known in the art for use in biscuits, cookies, or crackers may be used. Examples of sweeteners include any one or more of natural or artificial sweeteners, such as glucose, fructose, sucrose, lactose, mannose, maltose, fruit sugar, brown sugar, agave nectar, honey, high-fructose corn syrup, molasses, and the like; sugar alcohols such as sorbitol, xylitol, mannitol, maltitol, lactitol, erythritol, and the like; low or zero calorie sweeteners such as aspartame, Acesulfame potassium, Neotame, Stevia leaf extract, monk fruit extract, steviol glycosides, mogrosides, Saccharin, Sucralose, and the like; and mixtures thereof. In some aspects, sweeteners can be ground granulated, powdered (e.g., powdered or confectioners sugar), laminated, inverted sugar syrup, icing sugar, and the like. A dough can generally include any suitable amount of sweetener, such as amounts ranging from about 0.5 wt. % to about 30 wt. %, or from about 0.75 wt. % to about 27 wt. %, of a total weight of the dough.

A biscuit, cookie, or cracker as described herein also may comprise one or more baked dough portions and one or more fillings or toppings. For instance, the biscuit may comprise a sugar and/or fat-based filling sandwiched between biscuit or cookie layers. The fillings of such embodiments are preferably gluten-free.

A biscuit, cookie, or cracker as described herein can be optionally prepared from a dough generally including one or more suitable inclusions such as sugar-based inclusions; gelatinous inclusions; chocolate chips or chunks; chocolate drops, dried or hydrated fruit; caramel; toffee; nuts such as pecans, almonds, walnuts, cashews, and peanuts; candy pieces; sugar particles of various sizes; and the like. Any suitable amount of inclusions can be added to the types of dough described herein.

A dough or finished baked good can optionally include other additives such as any one or more of leaveners, baking powder (e.g. ammonium phosphate), flavorants (such as cocoa or chocolate liquor), colorants, emulsifiers (e.g. lecithin), hydrocolloids/gums, preservatives, salt, and whey.

A dough can generally be formed by mixing components such as water, flour, starch, fat, sweetener, leavening agent, and other optional materials. The inventors have surprisingly found that including a combination of gluten-free flour and pre-gelatinized starch provides a dough with taste and texture more similar to gluten-containing baked goods than other gluten-free or low-gluten alternatives. In particular, biscuits, cookies, and crackers containing gluten-free flour and pre-gelatinized starch, when baked, surprisingly have an improved snap and higher break force when compared to other gluten-free products. This result is unexpected given that pre-gelatinized starch is known to provide increased expansion (e.g., expanded ingredient matrix) in breads, and such teachings would not lend it to use as an ingredient to facilitate high strength properties in biscuits, cookies or crackers. Advantageously, conventional equipment and techniques may be used to manufacture and bake gluten-free dough of the type described herein, and ingredients do not need to be added in any particular order or under any specialized conditions.

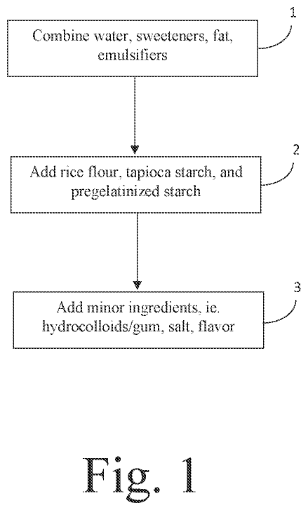

FIG. 1 shows a flow chart illustrating one example of a process for manufacturing a gluten-free biscuit in accordance with one embodiment of the present invention. In step 1, water, one or more sweeteners, one or more fats, and one or more emulsifiers are combined and mixed. In step 2, a wheat replacement system comprising rice flour, tapioca starch, and pre-gelatinized starch is added to the mixture. In step 3, minor ingredients such as hydrocolloids, gums, salt, and flavorants may be added to the mixture. Alternatively, the ingredients may be added in a different order or simultaneously to form a gluten-free dough. The dough may then be baked to form a finished biscuit, cookie, or cracker.

Non-limiting examples below demonstrate further aspects of specific embodiments of the invention.

### Control

A commercially available chocolate sandwich-type cookie (made with wheat flour containing gluten) was used as a control sample. The cookie portions of the Control include ingredients such as wheat flour, sugar, palm oil, canola oil, cocoa, high fructose corn syrup, and other additives. The cookie was made up of two chocolate-flavored cookie layers and an intermediate crème filling layer. The cookie was disassembled and the filling was discarded so that the individual cookie halves could be tested against other examples.

### Embodiment 1

A dough for preparing a chocolate sandwich-type cookie similar to the Control sample but free of gluten-containing ingredients was prepared by mixing the following components in a mixer (all percentages are by weight):

TABLE 1

| | Before | After |
|---|---|---|
| Ingredient | Baking | Baking |
| White Rice Flour | 15-18% | 14-16% |
| Tapioca Starch | 13-15 wt. % | 13-15 wt. % |
| Oat Flour | 9-10% | 9-10% |
| Pre-gelatinized corn starch | 6-8% | 7-9% |
| Gums | 0.1-1% | 0-1% |
| Sweeteners | 20-30 wt. % | 25-30 wt. % |
| Water | 8-9% | 0% |
| Fat | 10-11% | 12-13% |
| Flavor | 5-6% | 4-5% |
| Emulsifier | 0.5-1.5% | 0.7-1.7% |
| Leaveners | 0.3-0.7% | 0.4-0.8% |

The dough was baked to form a cookie similar in thickness to the halves of the Control. Light microscopy and confocal laser scanning microscopy indicated that starch was relatively evenly dispersed in this sample.

### Embodiment 2

A second dough for preparing a chocolate sandwich-type cookie similar to the Control sample but free of gluten-containing ingredients was prepared by mixing the following components in a mixer:

TABLE 2

| | Before | After |
|---|---|---|
| Ingredient | Baking | Baking |
| White Rice Flour | 6-8% | 5.5-7.5% |
| Brown Rice flour | 9-10% | 8.5-9.5% |
| Tapioca Starch | 14-15% | 14-15% |
| Oat Flour | 9-10% | 9.5-10.5% |
| Pre-gelatinized corn starch | 6-8% | 7-9% |
| Gums | 0.1-1% | |
| Sweeteners | 20-30% | 25-35% |
| Water | 8-9% | 0% |
| Fat | 10-11% | 12-13% |
| Flavor | 5-6% | 4-5% |
| Emulsifier | 0.5-1.5% | 0.7-1.7% |
| Leaveners | 0.3-0.7% | 0.4-0.8% |

The dough was baked to form a cookie similar in thickness to the halves of the Control. Light microscopy and confocal laser scanning microscopy indicated that starch was relatively evenly dispersed in this sample.

### Embodiment 3

A third dough for preparing a chocolate sandwich-type cookie similar to the Control sample but free of gluten-containing ingredients was prepared by mixing the following components in a mixer:

TABLE 3

| | Before | After |
|---|---|---|
| Ingredient | Baking | Baking |
| Fine White Rice Flour | 15-18% | 14-16% |
| Tapioca Starch | 13-15 wt. % | 13-15 wt. % |
| Oat Flour | 9-10% | 9-10% |
| Pre-gelatinized corn starch | 6-8% | 7-9% |
| Gums | 0.1-1% | 0-1% |
| Sweeteners | 20-30 wt. % | 25-30 wt. % |
| Water | 8-9% | 0% |
| Fat | 10-11% | 12-13% |
| Flavor | 5-6% | 4-5% |
| Emulsifier | 0.5-1.5% | 0.7-1.7% |
| Leaveners | 0.3-0.7% | 0.4-0.8% |

The dough was baked to form a cookie similar in thickness to the halves of the Control. Light microscopy and confocal laser scanning microscopy indicated that starch was relatively evenly dispersed in this sample.

### Comparative Examples A and B

Two different commercially available chocolate sandwich-type cookies advertised as gluten-free were obtained and disassembled. Comparative Example A was a Goodie Girl® chocolate creme cookie (Goodie Girl Tribeca LLC, Ridgefield NJ). According to its label, Comparative Example A contains ingredients such as sugar, rice flour, palm oil, corn starch, gluten free oat flour, tapioca starch, cocoa, soy lecithin, and other minor additives.

Comparative Example B was a Glutino® chocolate vanilla creme cookie (GFA Brands, Inc., Parmus NJ). According to its label, Comparative Example B includes tapioca flour, rice flour, vegetable shortening (palm oil, soybean oil, canola oil), confectioner's sugar, cocoa, water, tapioca syrup, corn starch, potato flour, soy lecithin, and other additives.

Each Comparative Example cookie was made up of two chocolate-flavored cookie layers and an intermediate vanilla cream filling layer. The cookies were disassembled and the filling was discarded so that the individual cookie halves could be tested against the Experimental Embodiments. Neither of the gluten free commercially available Comparative Examples employ the present inventive compositions.

### Comparison of Compositions

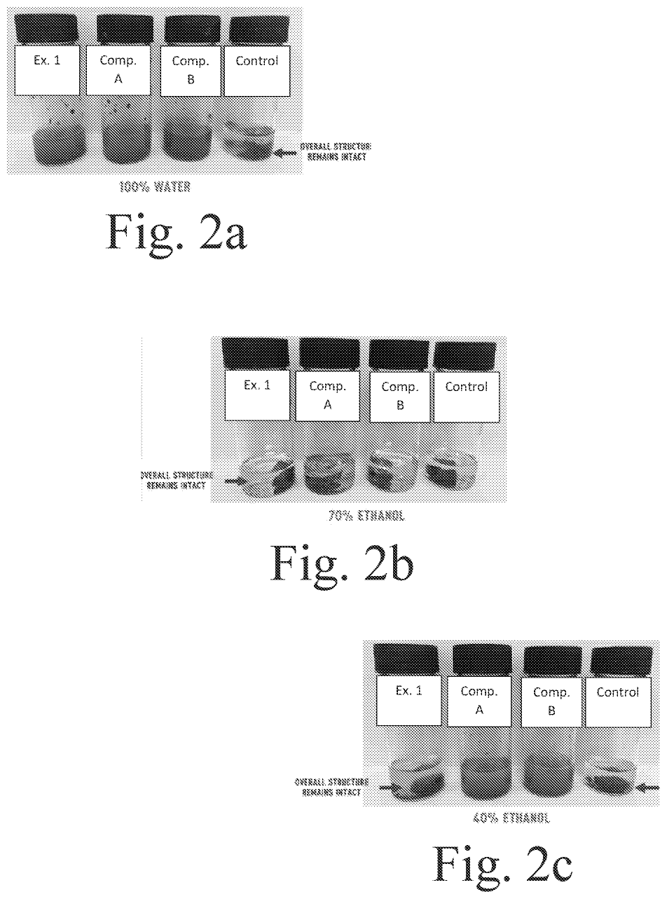

Embodiment 1 was tested for cohesiveness when placed in water and ethanol for one minute. As shown in FIGS. 2a-2c, the inventive sample exhibited cohesiveness more similar to the full-gluten Control sample than commercially available gluten-free Comparative Examples A and B. In FIG. 2a, portions of samples made according to the Control, Embodiment 1, and Comparative Examples A and B were placed in vials of 100% water for 1 minute. The inventive Embodiment 1 and Comparative Examples A and B all lost integrity and disintegrated in water, while the Control maintained structural integrity. Meanwhile, all samples retained structural integrity in 70% ethanol. However, as shown in FIG. 2c, while Comparative Examples A and B also disintegrated in 40% ethanol over a 1 minute span, inventive Embodiment 1 maintained structural integrity similar to the Control.

Light microscopy and confocal laser scanning microscopy were used to examine the distribution of starch and protein in each sample. Large areas of pre-gelatinized starch were identified in Embodiment 1 using light and confocal microscopy. Pre-gelatinized starch was not present in the standard gluten-containing Control product or either of the gluten free Comparative Example products. Based on these findings it is hypothesized, without being limited by theory, that the pre-gelatinized starch could help facilitate cohesion between the ungelatinized starch, remaining protein, and other ingredients of the inventive compositions presented herein, thus promoting high strength attributes, and in contrast to its role in other baked good products or ingredient systems.

The three inventive Embodiments were then measured for break force using a 3-point bend test and compared to the same two commercially available gluten-free cookie products described above. Two batches, denoted as A and B, were produced for each of inventive samples 1 and 2. A Tukey Pairwise Comparison was applied, resulting in 95% confidence. As shown in Table 5 below, inventive sample 3 had a significantly higher mean break force than both commercial samples, and inventive samples 1 and 2 exceeded the first commercial sample (Comparative A):

TABLE 4
Break Force of Samples

| | | Mean Break Force |
|---|---|---|
| SAMPLE | Number | (grams force) |
| Example 3 | 30 | 1736.6 |
| Comparative B | 30 | 1502.4 |
| Embodiment 1 (batch A) | 30 | 1388.6 |
| Embodiment 2 (batch B) | 30 | 1324.4 |
| Embodiment 2 (batch A) | 30 | 1239.9 |
| Embodiment 1 (batch A) | 30 | 1075.6 |
| Comparative A | 30 | 1022.7 |

This demonstrates that Example 1, Example 2, and Example 3 have a break force generally superior to commercial gluten-free cookies that do not employ the invention. High break force yields biscuits, cookies, and crackers that are more resistant to breakage during manufacturing, handling, shipping, and distribution. Such high break force and reduced breakage may reduce manufacturing waste or scrap material and positively impact a variety of manufacturing metrics such as speed or efficiency, and can also yield other advantages such as improved consumer experience. Embodiment 3 in particular had a superior break force to both Comparative Examples. Without being limited by theory, the inventive compositions also appear to exhibit a further synergistic and beneficial impact, on at least break force, as particle sizes decrease throughout the disclosed useable range. Below in Table 5 is shown particle size data of the flours and starches used in Embodiments 1, 2, and 3 as determined by Malvern Laser Diffraction:

TABLE 5
Particle Sizes of Flours/Starches

| | D10 | D50 | D90 |
|---|---|---|---|
| Ingredient | (μm) | (μm) | (μm) |
| White Rice Flour | 19.4 | 82.8 | 161 |
| (Examples 1 and 2) | | | |
| Fine White Rice | 6.42 | 33.6 | 96.8 |
| Flour (Example 3) | | | |
| Brown Rice Flour | 17.8 | 82.6 | 166 |
| Oat Flour | 14.5 | 111 | 557 |
| Tapioca Starch | 8.82 | 14.3 | 21.6 |
| Pre-Gelatinized | 24.9 | 109 | 282 |
| Starch | | | |

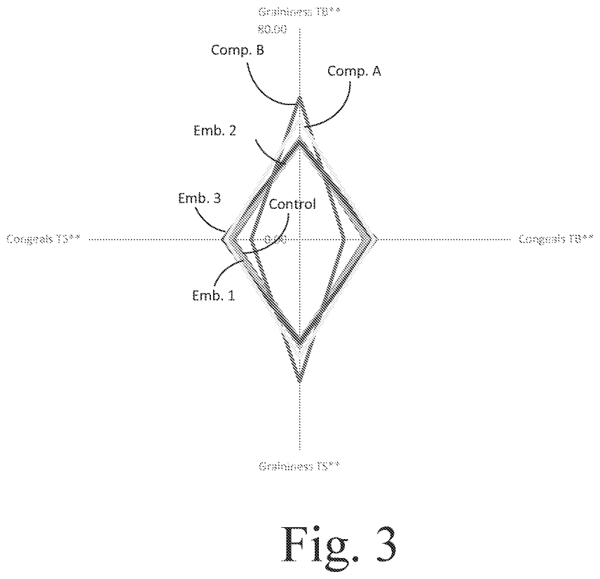

A panel also tested the various samples for sensory characteristics. Embodiments 1 and 3 were found to have a generally similar mouthfeel and texture profile, while Embodiment 2 was found to be slightly different. All of Embodiments 1-3 were found to have a more similar texture to the Control (gluten-containing cookie) than either Comparative Example A or B (commercially available gluten-free cookies). Results from the panel testing are shown in FIG. 3, which demonstrates that Embodiments 1, 2, and 3 were all perceived to be similar to the Control in terms of graininess and congeals, and more similar to the Control than Comparative Examples A and B. “Congeals” are a measure of how much the total product congeals into a bolus, with a low value indicating that the mass is spread around the mouth in many pieces (including loose particles), while a high value indicates clumping into a ball. Congeal values in the middle indicate a sample that forms a paste or loose mass in the mouth.

Comparative A and B were both perceived to have higher intensity graininess than the Control and Embodiments 1-3, and Comparative B was perceived to have lower congeals (less tendency to form a bolus in the mouth) when compared to all other samples. Without being limited to a particular theory, it is hypothesized that the use of pre-gelatinized starch leads to less graininess (particles) during chewing of baked product, and that nongelatinized starch granules linger to cause grainy mouthfeel. It is further believed that cookies having low moisture and high sugar yield little starch gelatinization during baking, and therefore gluten-free cookies made without pre-gelatinized starch appear to have a significantly more grainy texture than control cookies made with gluten. Thus, Embodiments 1-2 were not only shown to possess higher break force (or snap) as compared to Comparative Example A but also perceived to more closely approximate consumer preferred organoleptic attributes of gluten containing commercially available Control products. Embodiment 3 continues the trend of the inventive compositions by providing even greater snap while continuing to approximate consumer preferred organoleptic attributes of gluten-containing products unattainable by Comparative B despite Comparative B's high strength and use of some commonly available and similar ingredients. Still further, embodiments of the present invention can be utilized with conventional equipment and techniques, without attention to particular order of operation or under any specialized conditions, to achieve such preferable higher break force while also closely approximating preferred gluten-containing Control attributes.

### Comparison to Product with Commercial Gluten-Free Flour Blend

The Control and Embodiment 1 were further compared to an experimental cookie made with a commercially available gluten-free flour containing sweet white rice flour, whole grain rice flour, potato starch, whole grain sorghum flour, tapioca flour, and xanthan gum. Embodiment 1 was again found to be closer in texture, based on sensory analysis, to the gluten-containing Control as compared to the test product made with the commercially available gluten-free flour blend comprising potato starch.

### Solvent Retention Capacity Analysis

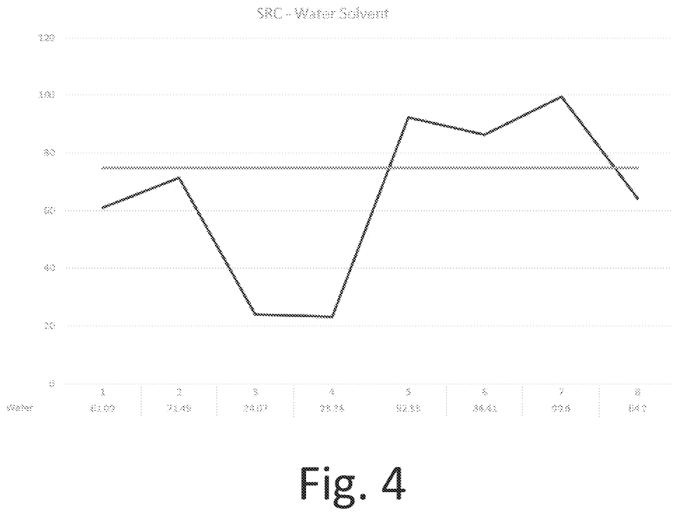

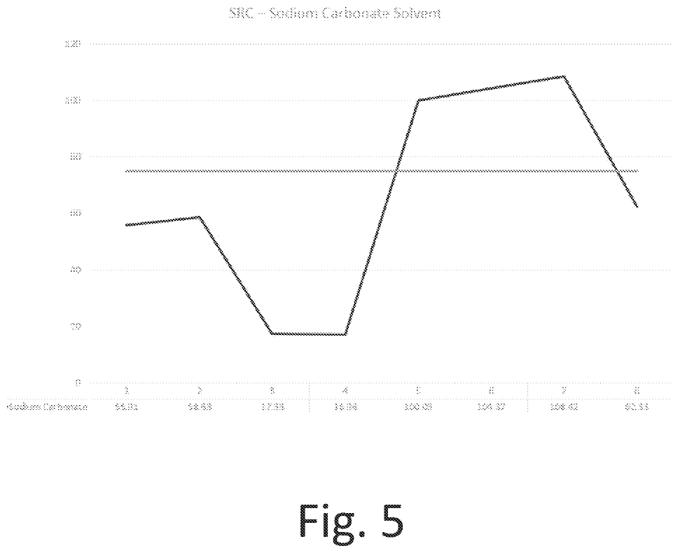

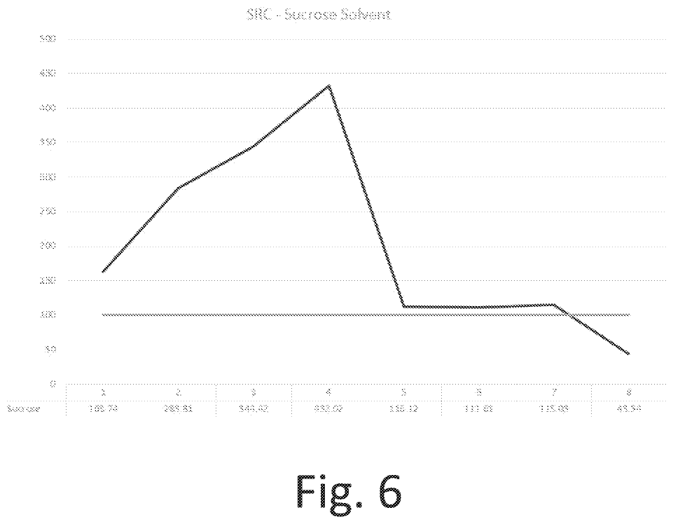

Several gluten-free sample cookies made with flour blends containing pre-gelatinized starch were created and compared to gluten-free comparative samples. The inventive samples were found to have texture superior to those of the comparative samples, and more similar to gluten-containing commercially available cookies. Solvent Retention Capacity (SRC) analysis was conducted on each flour blend, and solvent retention capacity data for these samples is shown in FIGS. 4-6. Each figure displays data for eight samples tested. Samples 1 and 2 are the flour/starch/hydrocolloid blend used in Embodiment 1 discussed above. Samples 3 and 4 are the flour/starch/hydrocolloid blend used in Embodiment 3 above. Sample 5 is a commercially-available gluten free four product, King Arthur® Gluten-Free Flour Measure for Measure, which is listed as containing rice flour, whole grain brown rice flour, whole sorghum flour, tapioca starch, potato starch, cellulose, and xanthan gum. Samples 6 and 7 are Bob's Red Mill® Gluten-Free 1 to 1 Flour, which is listed as containing sweet white rice flour, whole grain rice flour, potato starch, whole grain sorghum flour, tapioca flour, and xanthan gum. Sample 8 is Cup4Cup® Gluten-Free Multipurpose Flour, which is listed as containing cornstarch, white rice flour, brown rice flour, rBST-free milk powder, tapioca flour, potato starch, and xanthan gum. None of Samples 5-8 contained pre-gelatinized starch. FIG. 4 is a graph demonstrating that the preferred flour blends (Samples 1-4) had a water SRC of less than 75. FIG. 5 shows that the preferred flour blends had a sodium carbonate solution (5%) SRC of less than 75. FIG. 6 shows that the preferred flour blends had a sucrose solution (50%) SRC of greater than 100.

What is claimed is:

1. A gluten-free biscuit, cookie, or cracker comprising one or more gluten-free flours, 3-10 wt. % pre-gelatinized starch, 3-15 wt. % fat, and 1-32 wt. % sweetener.

2. The biscuit according to claim 1, wherein the one or more gluten-free flours comprise rice flour, oat flour, buckwheat flour, teff flour, sorghum flour, raw potato flour, or combinations thereof.

3. The gluten-free biscuit, cookie, or cracker according to claim 1, comprising about 0.2 to about 2 wt. % emulsifier.

4. The gluten-free biscuit, cookie, or cracker according to claim 1, wherein the pre-gelatinized starch is pre-gelatinized corn starch.

5. The gluten-free biscuit, cookie, or cracker according to claim 1, wherein the pre-gelatinized starch is waxy maize pre-gelatinized corn starch.

6. The gluten-free biscuit, cookie, or cracker according to claim 1, wherein the gluten-free flour has a D90 of less than about 125 μm.

7. The gluten-free biscuit, cookie, or cracker according to claim 1, wherein the gluten-free flour has a D50 of less than about 60 μm.

8. The gluten-free biscuit, cookie, or cracker according to claim 1, wherein the gluten-free flour has a D10 of less than about 15 μm.

9. The gluten-free biscuit, cookie, or cracker according to claim 1, wherein the gluten-free flour has a solvent retention capacity for a 50% sucrose solution of greater than 100, a solvent retention capacity for a 5% sodium carbonate solution below 75, and a solvent retention capacity for water of below 75.

10. A gluten-free dough comprising 40-60 wt. % of a wheat flour substitute, the wheat flour substitute comprising about 30-70 wt. % gluten-free flour, about 5-25 wt. % pre-gelatinized starch, and 0.5-1.5 wt. % hydrocolloid.

11. The dough according to claim 10, wherein the gluten-free flour comprises rice flour, oat flour, buckwheat flour, teff flour, sorghum flour, raw potato flour, or combinations thereof.

12. The dough according to claim 10, wherein the pre-gelatinized starch is pre-gelatinized corn starch.

13. The dough according to claim 10, wherein the gluten-free flour has a D90 of less than about 125 μm.

14. The dough according to claim 10, wherein the gluten-free flour has a D10 of less than about 15 μm.

15. The dough according to claim 10, wherein the gluten-free flour has a solvent retention capacity for a 50% sucrose solution of greater than 100, a solvent retention capacity for a 5% sodium carbonate solution below 75, and a solvent retention capacity for water of below 75.

16. An edible gluten-free product comprising 3-10 wt. % pre-gelatinized starch, 3-15 wt. % fat, and 1-32 wt. % sweetener, the gluten-free product prepared from a dough comprising 40-60 wt. % of a wheat flour substitute, the wheat flour substitute comprising about 30-70 wt. % of the gluten-free flour, about 5-25 wt. % of the pre-gelatinized starch, and 0.5-1.5 wt. % hydrocolloid.

17. The product according to claim 16, wherein the gluten-free flour comprises rice flour, oat flour, buckwheat flour, teff flour, sorghum flour, raw potato flour, or combinations thereof.

18. The product according to claim 16, wherein the pre-gelatinized starch is pre-gelatinized corn starch.

19. The product according to claim 16, wherein the gluten-free flour has a D90 of less than about 125 μm.

20. The product according to claim 16, wherein the gluten-free flour has a solvent retention capacity for a 50% sucrose solution of greater than 100, a solvent retention capacity for a 5% sodium carbonate solution below 75, and a solvent retention capacity for water of below 75.
